(19) United States
(12) Patent Application Publication
(10) Pub. No.: US 2020/0018114 A1
(43) Pub. Date: Jan. 16, 2020

(54) SOLAR POWER GENERATOR AND SOLAR POWER GENERATING BLIND

(71) Applicant: LG ELECTRONICS INC., SEOUL (KR)

(72) Inventors: Junghwan YEOM, SEOUL (KR); Yong SONG, SEOUL (KR); Jeonghun WOO, SEOUL (KR); Joonho JEON, SEOUL (KR); Yoonsuk CHOI, SEOUL (KR)

(73) Assignee: LG ELECTRONICS INC., SEOUL (KR)

(21) Appl. No.: 16/510,563

(22) Filed: Jul. 12, 2019

(30) Foreign Application Priority Data
Jul. 13, 2018 (KR) 10-2018-0081734

(51) Int. Cl. E06B 9/322; H02S 30/20

(52) U.S. Cl. CPC E06B 9/322; E06B 2009/2476; H02S 30/20

(57) ABSTRACT

Disclosed is a solar power generator including a plurality of solar cell module-mounted plates, each plate having an elongate shape extending in a first direction, where the plates are connected in parallel with each other, wherein each of the solar cell module-mounted plates includes: an elongate plate extending in the first direction; and a plurality of solar cell modules mounted on the elongate plate; wherein each of the solar cell modules includes a plurality of solar cells.

### CROSS-REFERENCE TO RELATED APPLICATION

This application claims priority to and the benefit of Korean Patent Application No. 10-2018-0081734, filed in the Korean Intellectual Property Office on Jul. 13, 2018, the entire contents of which are incorporated herein by reference.

### BACKGROUND OF THE INVENTION

### Field of the Invention

The present disclosure relates to a solar power generator and a solar power generating blind, and more particularly to a solar power generator and a solar power generating blind having an improved structure and thus applicable to various devices or locations.

### Related Art

In general, a solar power generator can include a solar cell module in which a plurality of solar cells are connected in series or in parallel and packaged. A typical solar cell module has a flat structure in which a plurality of solar cells are arranged in one direction and in a direction intersecting the same in one body having a large area so as to produce a desired output. A solar cell module having a flat plate structure or a solar power generator including the same may not be installed in a narrow area and has no aesthetic characteristic.

Recently, a solar power generator having various structures other than a flat plate structure has been proposed. For example, a solar power generator is proposed in which a solar cell module is placed on each slat of a blind, and the modules are electrically connected to each other.

However, since the solar power generator applied to the blind has a spatial restriction due to its shape and installation location, there is a limit to the number of solar cell modules that can be mounted on each blind slat. Thus, because of the limited voltage that can be generated in each slat, a plurality of slats are connected in series to generate the voltage required to start the inverter of the solar power generator. Thus, when the plurality of slats are connected in series, a bypass diode is required to prevent one blind from stopping the generation of another blind due to the shadow or the like from the one blind. However, in the solar power generator applied to the blind, when an junction box equipped with the bypass diode is separately provided, it is difficult to stably install the generator because the total weight thereof is heavy. Further, the connection structure thereof with the junction box becomes complicated. The blind operation may not be smooth, or the appearance thereof can be deteriorated.

### SUMMARY OF THE INVENTION

The present disclosure is to provide a solar power generator having a solar cell module-mounted plate having a long structure extending in one direction rather than a flat structure, in which the power generator can be applied to various devices or locations and has excellent aesthetic characteristics. In this connection, the present disclosure is to provide a solar power generator that does not have a bypass diode and a junction box for the diode, thus to have the simplified structure. In this connection, the present disclosure is to provide a solar power generator in which the number and arrangement of the solar cell module-mounted plate, the solar cell modules mounted on the plate, and the solar cells of the solar cell module can be adjusted to remove the bypass diode and the junction box for the diode and thus to achieve a small volume and excellent aesthetic characteristics.

In particular, the present disclosure is to provide a solar power generating blind capable of generating solar power while excellently performing a blind function to block or control external light.

In one aspect of the present disclosure, there is provided a solar power generator having a structure that can be applied to various devices and locations, wherein the generator includes a plurality of solar cell module-mounted plates, each plate having an elongate shape extending in a first direction, where the plates are connected in parallel with each other, wherein each of the solar cell module-mounted plates includes: an elongate plate extending in the first direction; and a plurality of solar cell modules mounted on the elongate plate; wherein each of the solar cell modules includes a plurality of solar cells. In one implementation, the solar cell has a rear-face electrode structure, wherein each of the solar cell modules includes a circuit board, a circuit sheet, a circuit unit having a pattern defined thereon for serially connecting the plurality of solar cells to each other.

In one implementation, the solar power generator is used as a blind including each solar cell module-mounted plate as a slat thereof.

In one implementation, the solar cell has an area of 100 mm² to 2120 mm², wherein the solar cell module-mounted plate includes 14 to 60 solar cells.

In one implementation, the generator further comprises an inverter for converting direct current generated from the solar cell module-mounted plate or the solar cell modules mounted on the solar cell module-mounted plate into alternate current, wherein a total output voltage from the plurality of solar cells located on each solar cell module-mounted plate is higher than a starting voltage for the inverter.

In one implementation, the solar cell module-mounted plate is connected to the inverter without a bypass diode.

In one implementation, a total output voltage from the plurality of solar cells located on each solar cell module-mounted plate is 15V or greater.

In one implementation, the solar cell has a long side and a short side, wherein the long side of the solar cell extends in a second direction intersecting the first direction. The plurality of solar cells can be connected to each other in the first direction via the pattern of the circuit board.

In one implementation, the pattern of the circuit board can be formed over the first and second solar cells adjacent to each other in the first direction among the plurality of solar cells.

In one implementation, the circuit board is located on one face of each of the plurality of solar cells, wherein the solar cell module further includes a cover member located on an opposite face of the plurality of solar cells, and a sealing member positioned between the plurality of solar cells and the cover member.

In one implementation, in the solar cell module-mounted plate, each solar cell module includes a plurality of solar cell modules connected in series to each other.

In one implementation, the solar cell module is connected to an adjacent solar cell module or to an external circuit via a conductive connector.

In one aspect of the present disclosure, there is provided a solar power generating blind device including a plurality of slats, each slat having an elongate shape extending in a first direction, where the slats are connected in parallel with each other, wherein each of the slats includes: an elongate plate extending in the first direction; and a plurality of solar cell modules mounted on the elongate plate; wherein each of the solar cell modules includes: a plurality of solar cells, each having a rear-face electrode structure; and a circuit board, a circuit sheet, or a circuit unit for connecting the plurality of solar cells in series to each other.

According to this embodiment, the solar cell module including the plurality of solar cells having a rear-face electrode-type structure and the circuit board connecting the plurality of solar cells to each other is provided on the solar cell module-mounted plate. Thus, the solar cell module-mounted plate having a very small thickness and extending in the first direction can be formed. Accordingly, the generator can have almost the same shape or structure as a conventional general blind while including the solar cell or the solar cell module. As a result, the solar power generator can sufficiently perform its role and improve the aesthetic characteristics.

In particular, in this embodiment, the plurality of solar cells, each having a predetermined area are provided on the solar cell module-mounted plate so that the inverter can be started up using a voltage generated from one solar cell module-mounted plate. Thus, the plurality of solar cell module-mounted plates connected in parallel to each other and may not have the bypass diode. This eliminates the bypass diode and junction boxes, thus, simplifying the structure of the generator and minimizing volume thereof. The plurality of solar cell module-mounted plates can be provided to have a desired sufficient power. Therefore, the solar power generator can be formed into various structures, such that the generator can be applied to various positions, various purposes, and various devices.

### BRIEF DESCRIPTION OF THE DRAWINGS

FIG. 1 is a perspective view schematically illustrating a solar power generator according to an embodiment of the present disclosure.

FIG. 2 shows a schematic configuration diagram of the solar power generator shown in FIG. 1.

FIG. 3 is an exploded perspective view of one of solar cell modules included in the solar power generator shown in FIG. 1.

FIG. 4 is a schematic plan view of the solar cell module shown in FIG. 3.

FIG. 5 is front-face and rear-face plan views of one solar cell included in the solar cell module shown in FIG. 4.

FIG. 6 is front-face and rear-face plan views of a circuit board included in the solar cell module shown in FIG. 3.

FIG. 7 is a rear-face plan view schematically showing a plurality of solar cell modules included in one solar cell module-mounted plate included in the solar power generator shown in FIG. 2.

FIG. 8 is a schematic configuration diagram of a solar power generator according to a variation of the present disclosure.

### DESCRIPTION OF EXEMPLARY EMBODIMENTS

For simplicity and clarity of illustration, elements in the figures are not necessarily drawn to scale. The same reference numbers in different figures denote the same or similar elements, and as such perform similar functionality. Furthermore, in the following detailed description of the present disclosure, numerous specific details are set forth in order to provide a thorough understanding of the present disclosure. However, it will be understood that the present disclosure can be practiced without these specific details. In other instances, well-known methods, procedures, components, and circuits have not been described in detail so as not to unnecessarily obscure aspects of the present disclosure. Examples of various embodiments are illustrated and described further below. It will be understood that the description herein is not intended to limit the claims to the specific embodiments described. On the contrary, it is intended to cover alternatives, modifications, and equivalents as can be included within the spirit and scope of the present disclosure as defined by the appended claims.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “at least one of” when preceding a list of elements can modify the entire list of elements and may not modify the individual elements of the list. It will be understood that, although the terms “first”, “second”, “third”, and so on can be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will also be understood that when a first element or layer is referred to as being present “on” or “beneath” a second element or layer, the first element can be disposed directly on or beneath the second element or can be disposed indirectly on or beneath the second element with a third element or layer being disposed between the first and second elements or layers. It will be understood that when an element or layer is referred to as being “connected to”, or “coupled to” another element or layer, it can be directly on, connected to, or coupled to the other element or layer, or one or more intervening elements or layers can be present. In addition, it will also be understood that when an element or layer is referred to as being “between” two elements or layers, it can be the only element or layer between the two elements or layers, or one or more intervening elements or layers can also be present.

Hereinafter, a solar power generator according to an embodiment of the present disclosure will be described in detail with reference to the accompanying drawings.

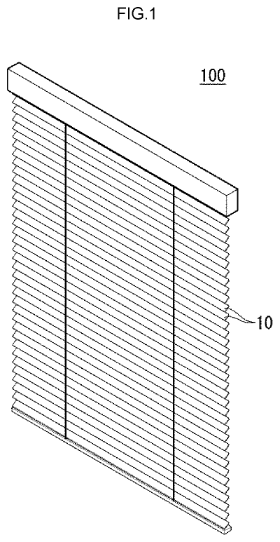

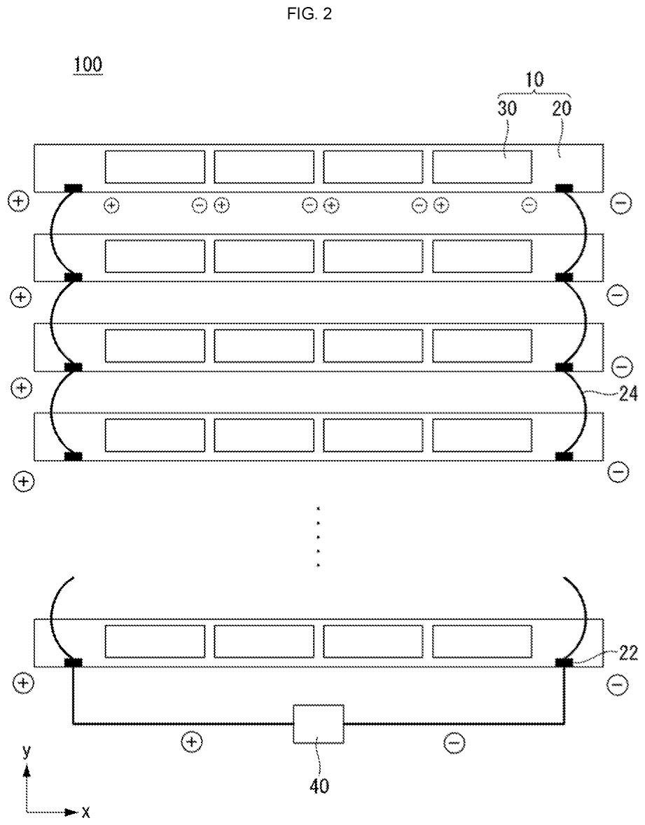

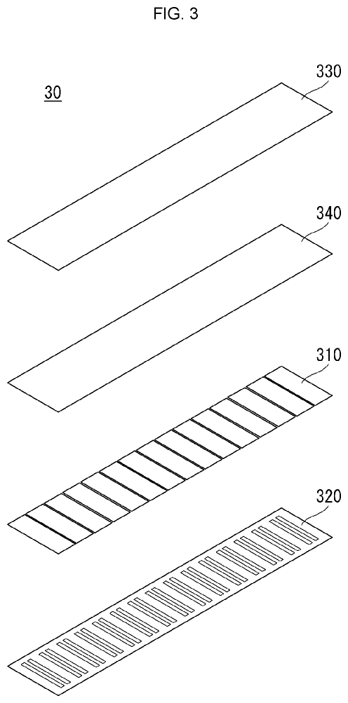

FIG. 1 is a perspective view schematically illustrating a solar power generator 100 according to an embodiment of the present disclosure. FIG. 2 is a schematic configuration diagram of the solar power generator 100 shown in FIG. 1, and FIG. 3 is an exploded perspective view showing one solar cell module 30 included in the solar power generator 100 shown in FIG. 1.

Referring to FIGS. 1 to 3, the solar power generator 100 according to the present embodiment includes a plurality of solar cell module-mounted plates 10, each having a shape extending in the first direction (in the x-axis direction), the plates being arranged in the second direction (in the y-axis direction) and being in parallel to each other. In this connection, each solar cell module-mounted plate 10 includes an elongate plate 20 extending in the first direction and a solar cell module 30 mounted on the elongate plate 20. Each solar cell module 30 includes a plurality of solar cells 310 having a rear-face electrode structure, and a circuit board 320 for connecting the plurality of solar cells 310 in series. In this connection, each solar cell module-mounted plate 10 can include the plurality of solar cell modules 30 connected in series with each other. The solar power generator 100 further includes an inverter 40 for converting a direct current generated from the plurality of solar cell module-mounted plates 10 into AC.

For example, the solar power generator 100 according to the present embodiment has a louver type structure. In this case, the plurality of solar cell module-mounted plates 10 are partially or wholly overlapped. Thus, the solar power generator 100 can be used as a solar power generating blind in which the plurality of solar cell module-mounted plates 10 are applied to a manual or automatic blind which can adjust a length thereof, light quantity and so on. In this connection, each solar cell module-mounted plate 10 of the solar power generator 100 can act as a respective slat or blade of the blind.

More specifically, referring to FIG. 2, each elongate plate 20 has a certain width and length such that each elongate plate 20 has an area such that the plate can act as a blind slat which block the sunlight if not desired. For example, the elongate plate 20 can have a length such that the plurality of solar cell modules 30 can be attached thereto and have a width such that each solar cell module 30 can be attached thereto. The width and length of the elongate plate 20 can be varied according to the area, thickness, number, etc. of the solar cell module 30. This elongate plate 20 can be made of a variety of materials to support the solar cell module 30 and have the strength needed to function as the slat. The elongate plate 20 can be made of a non-conductive material, for example, a resin, an insulating material-coated metal, or the like. For example, an example of the material of the elongate plate 20 can include a copolymer of acrylic rubber (e.g., acrylonitrile styrene acrylate (ASA), polycarbonate poly (PC), anodizing aluminum (aluminum having an aluminum oxide coating thereon.

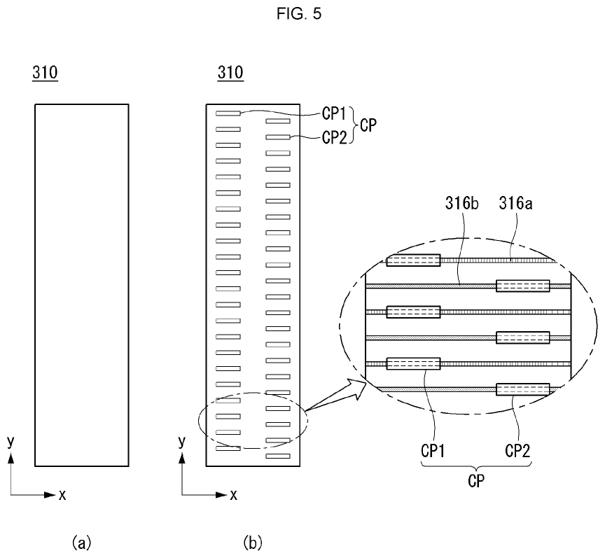

In this embodiment, the plurality of solar cell module-mounted plates 10 can be arranged in the second direction intersecting the first direction. In this connection, the plurality of solar cell module-mounted plates 10 arranged in the direction perpendicular to the first direction can be connected in parallel with each other. That is, first electrodes (reference numeral 316a in FIG. 5, hereinafter, the same reference numeral) of the solar cell modules 30 located on the plurality of solar cell module-mounted plates 10 can be connected to each other in one end of each of the plurality of solar cell module-mounded plates 10. Second electrodes (reference numeral 316b in FIG. 5, hereinafter, the same reference numeral) of the solar cell modules 30 located on the plurality of solar cell module-mounted plates 10 can be connected to each other in the other end of each of the plurality of solar cell module-mounded plates 10. In this way, the plurality of solar cell module-mounted plates 10 can be connected to each other using a simple connection structure. For example, a terminal 22 formed on each of the plurality of solar cell module-mounted plates 10 and connected to the first electrode 316a or the second electrode 316b, and a connector 24 for connecting adjacent terminals 22 in parallel with each other can be provided. The terminal 22 and the connector 24 can employ various structures and connection schemes. For example, a cable or the like can be used as the connector. Alternatively, a flat circuit structure such as a flexible printed circuit board (FPCB), a flexible flat cable, or the like can be used as the connector. However, the present disclosure is not limited thereto.

In this embodiment, each solar cell module-mounted plate 10, more specifically, a plurality of solar cell modules 30 connected in series to each other and mounted on each solar cell module-mounted plate 10 can generate a voltage larger than a starting voltage for starting the inverter 40. This will be described in more detail later. Accordingly, even when only one solar cell module-mounted plate 10 can generate a voltage although the solar cell module-mounted plates 10 are connected in parallel to each other, the inverter 40 can be started. Thus, even when some of the solar cell module-mounted plates 10 do not work due to shadows, the power generation of the corresponding solar cell module-mounted plates 10 is halted but the remaining solar cell module-mounted plates 10 can generate electricity to maximize the generation amount. Accordingly, it is not necessary to provide a bypass diode, which is essential when the plurality of solar cell module-mounted plates are connected in series to each other. Accordingly, the bypass diode and the junction box for the bypass diode are not required. As shown in FIG. 2, the solar cell module-mounted plates 10 can be directly connected to the inverter 40 using the connector 22 or the like without the bypass diode. Thus, the solar power generator 100 used as the blind can be stably installed, and the connection structure in the solar power generator 100 can be simplified such that the non-desirable influence may not be applied to the blind operation and the aesthetics of the solar power generator 100 can be improved.

In this embodiment, the solar cell module 30 can be fixed to the solar cell module-mounted plate 10 by various methods, structures, schemes and the like.

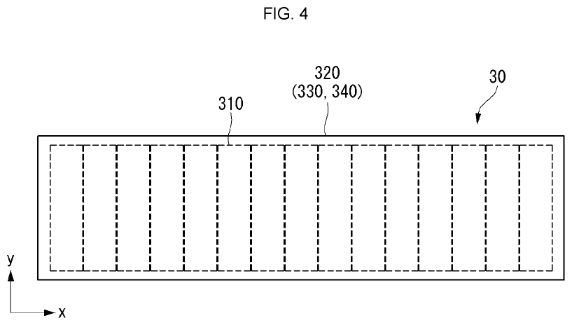

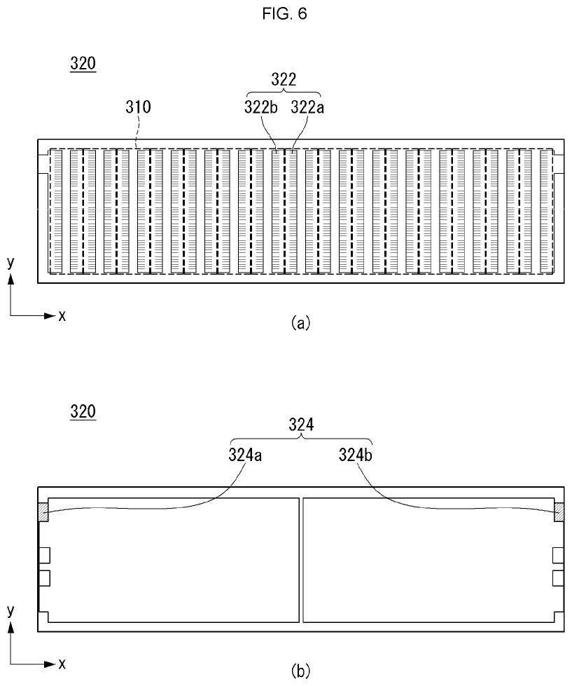

Hereinafter, one solar cell module 30 included in the solar cell module-mounted plate 10 will be described in detail with reference to FIG. 3 and FIG. 4 to FIG. 6. FIG. 4 is a schematic plan view of the solar cell module shown in FIG. 3. FIG. 5 is front-face and rear-face plan views of one solar cell included in the solar cell module shown in FIG. 4. FIG. 6 is front-face and rear-face plan views of a circuit board included in the solar cell module shown in FIG. 3. In FIG. 5 and FIG. 6, (a) shows a front-face plan view, and (b) shows a rear-face plan view.

Referring to FIGS. 3 to 6, the solar cell module 30 according to the present embodiment includes a plurality of solar cells 310 and a circuit board 320 located on one face (for example, a rear face) of each of the plurality of solar cells 310. The module 30 can further include a cover member 330 positioned on an opposite face (e.g., a front-face) of each of the plurality of solar cells 310, and a sealing member 340 positioned between the plurality of solar cells 310 and the cover member 330.

In this embodiment, each of the plurality of solar cells 310 have a rear-face electrode type structure in which the first electrode 316a and the second electrode 316b connected to a conductive region and having opposite polarities or conductive types to each other are disposed on the rear face of each of the respective solar cells 310 (that is, a face contacting the circuit board 320). In this connection, the solar cell 310 can have a long side and a short side. The long side of the solar cell 310 extends in the y-axis direction as the second direction that intersects with the first direction in which the solar cell module-mounted plate 10 or the solar cell module 30 extends. The short side of the solar cell 310 extends in the first direction. The plurality of solar cells 310 can be arranged in the first direction. As described above, the plurality of solar cells 310 can be provided to maximize the voltage generated from the solar cell module 30 including the plurality of solar cells or the solar cell module-mounted plate 10. Although the neighboring solar cells 310 are shown as being in contact with each other in FIG. 4 and FIG. 6, the neighboring solar cells 310 can be spaced apart from each other in the first direction by a certain distance.

In each solar cell 310, each of the first electrode 316a and the second electrode 316b can extend along the short side direction or the first direction of the solar cell 310. A first connection portion CP1 can be located on one side (a left side) to the first electrode 316a in the short side direction. A second connection portion CP2 can be located on the other side (right side) to the second electrode 316b in the short side direction. The connection portion CP can include various materials capable of electrically and/or physically connecting the first and second electrodes 316a and 316b to a pattern 322 of the circuit board 320. In this connection, an insulating member for insulation (not shown) can be further provided on the other side to the first electrode 316a and the one side to the second electrode 316b in the short side direction which does not participate in connection with the circuit board 320. FIG. 5 shows only the connection portion CP for a brief overview and a clear understanding.

The solar cell 310 is fixed to the circuit board 320. The circuit board 320 includes a pattern 322 for connecting the plurality of solar cells 310 in series to each other. The plurality of solar cells 310 included in each solar cell module 30 are electrically connected to each other in the first direction via the pattern 332. More specifically, a plurality of patterns 332 are provided on one face (i.e., front-face) of the circuit board 320 on which the plurality of solar cells 310 are fixed. Each pattern 332 can include a first pattern 322a connected to a first electrode 316a or a first connection portion CP1 and a second pattern 322b connected to a second electrode 316b or a second connection portion CP2. In each pattern 322, the first pattern 322a can be connected to the first electrode 316a or the first connection portion CP1 of the first solar cell of the plurality of solar cells 310, while the second pattern 322b can be connected to the second electrode 316b or the second connection portion CP2 of the second solar cell adjacent to the first solar cell. That is, each pattern 322 can be formed across the first and second solar cells adjacent to each other in the first direction. When this connection structure is repeated, the plurality of solar cells 310 can be connected in series to each other.

On the other face of the circuit board 320, that is, the rear-face thereof, a pad 324 for connection to another solar cell module 30, more specifically, a circuit board 320 included in another solar cell module 30 can be disposed. The pad 324 is electrically connected to the pattern 322 located on the front-face. The pad 324 is disposed on one side in the first direction and includes a first pad 324a electrically connected to the first electrode 316a or the first pattern 322a and a second pad 324b electrically connected to the second electrode 316b or the second pattern 322b.

In the drawings and the description, it is illustrated that each solar cell 310 is provided only with the first connection portion CP1 constituting one column in the second direction and a second connection portion CP2 constituting one column in the second direction. However, the present disclosure is not limited thereto. Accordingly, each solar cell 310 can have the first connection portion CP1 that constitutes a plurality of columns and/or the second connection portion CP2 that constitutes a plurality of columns. In this case, the columns of the first connection portions CP1 and the columns of the second connection portions CP2 can be alternately arranged in the first direction. In this connection, the pattern 322 of the circuit board 320 can have various connection structures by which the first electrode 316a or the first connection portion CP1 of the first solar cell of the plurality of solar cells 310 and the second electrode 316b or second connection portion CP2 of the second solar cell adjacent to the first solar cell can be connected to each other.

Known various materials for the cover member 330 can be used. For example, a resin or a film having transparency can be used. Thus, the weight of the solar cell module 30 can be reduced, so that the module can be stably installed in the blind. The sealing member 340 can employ various materials that can prevent moisture and oxygen from entering the solar cells and chemically combine the elements of the solar cell module 30. For example, the sealing member 340 can be made of an ethylene-vinyl acetate copolymer resin (EVA), polyvinyl butyral, a silicone resin, an ester-based resin, an olefin-based resin, or the like.

The solar cell module 30 according to the present embodiment has the circuit board 320 on one face thereof. The circuit board 320 can be fixed onto the elongate plate 20, so that no separate cover member is used to cover the rear face. However, a separate cover member and sealing member can be located on the rear face of the solar cell module 30. Although the circuit board 320 is fixed to the separate elongate plate 20 in the present embodiment, it is possible that the separate elongate plate 20 is not provided and the circuit board 320 serves as the elongate plate and the elongate plate 20 is not omitted.

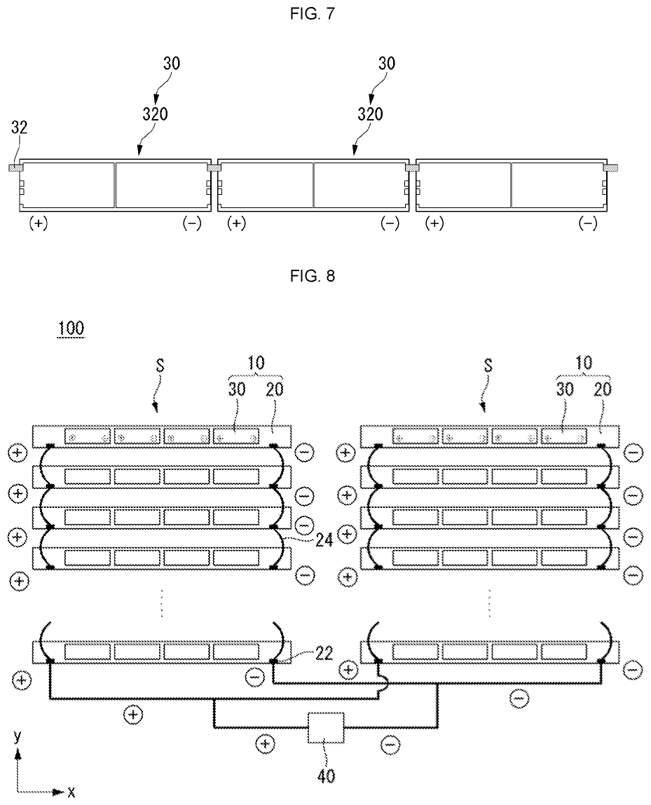

The plurality of solar cell modules 30 as described above can be connected in series to each other on each solar cell module-mounted plate 10. In this case, the length of each solar cell module 30 is not excessively increased to improve the stability of each solar cell module 30 while the plurality of solar cells 310 are provided to maximize the voltage that can be generated from the solar cell module-mounted plates 10. The plurality of solar cell modules 30 provided in each solar cell module-mounted plate 10 can be connected in series to each other via various schemes, structures, etc. An example thereof will be described in detail with reference to FIG. 6 and FIG. 7.

FIG. 7 is a rear-face plan view schematically showing a plurality of solar cell modules 30 included in one solar cell module-mounted plate 10 included in the solar power generator shown in FIG. 2. The polarity (+), (−) in FIG. 2, FIG. 6 and FIG. 7 are shown for the sake of understanding and the present disclosure is not limited thereto.

Referring to FIGS. 6 and 7, each of the plurality of solar cell modules 30 included in each solar cell module-mounted plate extends in the first direction. Each of the plurality of solar cell modules 30 can be connected to an adjacent solar cell modules 30 or to the outside via an interconnector member 32. For example, the interconnector member 32 is electrically and physically connected to the pad 324 of the circuit board 320 of each solar cell module 30 such that the corresponding circuit board 320 is connected to a circuit board 320 of a neighboring solar cell module 30, to a circuit board 320 of a solar cell module 30 located on another solar cell module-mounted plate 10, or to an external circuit. For example, two neighboring solar cell modules 30 are spaced apart from each other by a predetermined distance in the first direction. The first pad 324a of one solar cell module 30 and the second pad 324b of the neighboring solar cell module 30 thereto can be connected to each other via the interconnector member 32 extending in the first direction. The interconnector member 32 can be embodied as a ribbon which can be connected to the pad 324 by soldering. However, the present disclosure is not limited thereto. The material, connection method, and shape of the interconnector member 32 can be variously modified.

In the above-described embodiment, the plurality of solar cell modules 30 adjacent to each other in the first direction are connected in series to each other in one solar cell module-mounted plate 10 extending in the first direction, and the plurality of solar cell module-mounted plates 10 are connected in parallel to each other and then are connected to the inverter 40. However, the present disclosure is not limited to this configuration. Therefore, as shown in FIG. 8, the plurality of solar cell module-mounted plates 10 can be arranged in the first direction. In this connection, the plurality of solar cell modules 30 mounted on the plurality of solar cell module-mounted plates 10 located at the same position in the first direction and arranged in a direction intersecting the first direction can constitute one string S. Thus, a plurality of strings S can be arranged in the first direction. The plurality of strings S arranged in the first direction can be connected in parallel to each other and then can be connected to the inverter 40. However, the present disclosure is not limited to this configuration. The plurality of strings S can be connected in various structures. Further, in the first direction, a single solar cell module-mounted plate 10 or a single elongate plate 20 is present, while a first subgroup in which a plurality of solar cell modules 30 located in one solar cell module-mounted plate 10 or one elongate plate 20 are connected to each other in series with each other, and a second subgroup in which a plurality of solar cell modules 30 located in one solar cell module-mounted plate 10 or one elongate plate 20 are connected to each other in series with each other are present. In this connection, the modules of the first subgroup are arranged in the second direction and the modules of the second subgroup are arranged in the second direction. In this connection, the modules of the first and second subgroups located in the same direction in the first direction can be connected to each other in a parallel manner to constitute a string S. Various other variations are possible.

According to the present embodiment, each solar cell module-mounted plate 10 has a plurality of solar cells 310 having a relatively small area, such that the output voltage of the plurality of solar cells 310 located on each solar cell module-mounted plate 10 can be greater than the starting voltage for the inverter 40. For example, each solar cell module-mounted plate 10 is provided with 14 to 60 (e.g., greater than 22) solar cells 310, each having an area of 100 mm² to 2120 mm² and thus generates a voltage (for example, a voltage of 15 V or greater) required for starting the inverter 40. For example, each solar cell module-mounted plate 10 can have an area of 400 mm² to 424 mm². A current in each solar cell module-mounted plate 10 can be lower than or equal to 0.17 amperes. However, the present disclosure is not limited to this configuration. Even when the starting voltage for the inverter 40 changes in accordance with the power generation of the inverter 40, it can suffice when the output voltage from the plurality of solar cells 310 of each solar cell module-mounted plate 10 is larger than the starting voltage for the inverter 40. Accordingly, the plurality of solar cell module-mounted plates 10 can be connected in parallel to each other, such that a separate bypass diode is not provided. In this connection, a block diode can be provided as needed. However, the block diode may not be provided. Further, the voltage required for each solar cell module-mounted plate 10 can be easily adjusted by adjusting the area and number of the solar cell 310, thereby greatly improving the degree of freedom of design. Conventionally, when the current is large, a problem such as hot spot due to current concentration can occur. For this reason, the bypass diode is required for each solar cell module-mounted plate 10. However, in this embodiment, even when the output loss due to the lowering of the current flowing through each solar cell module-mounted plate 10 is taken into consideration, the current can be lowered and the bypass diode may not be provided.

According to the present embodiment, the solar cell module 30 including a plurality of solar cells 310 having a rear-face-electrode-type structure and a circuit board 320 for connecting the plurality of solar cells 310 to each other is provided on a solar cell module-mounted plate 10. Thus, the solar cell module-mounted plate 10 having a very small thickness and extending in the first direction can be formed. Accordingly, the solar power generator can have almost the same shape or structure as the conventional general blind while having the solar cell 310 or the solar cell module 30. As a result, the solar power generator 100 can sufficiently perform its role and have the improved aesthetic characteristics.

Particularly, in this embodiment, a plurality of solar cells 310, each having a predetermined area are provided on the solar cell module-mounted plate 10. Thus, the inverter 40 can be started by the voltage generated from one solar cell module-mounted plate 10. Thus, the plurality of solar cell module-mounted plates 10 can be connected in parallel to each other and thus the present solar power generation may not have the bypass diode. That is, photoelectric conversion is performed using each solar cell module-mounted plate 10 as a basic unit. Thus, when the shadows, defects, etc. occur, the photoelectric conversion of the corresponding solar cell module-mounted plate 10 subjected to the effect thereof is not performed, but the photoelectric conversion is performed in the other solar cell module-mounted plates 10. As a result, it is possible to effectively reduce problems such as reduction in power generation amount caused by shadows, defects, and hot spots. Eliminating the bypass diode and junction box can allow the structure of the generator to be simplified and allow the volume thereof to be minimized. In the solar power generator 100, the plurality of solar cell module-mounted plates 10 can be provided to provide a desired output. Accordingly, the solar power generator 100 can be formed in various structures, and thus can be applied to various positions, various purposes, and various devices.

In this embodiment, the solar cell 310 can be formed of a silicon crystalline solar cell. Then, each solar cell 310 can have a good generation amount. However, the present disclosure is not limited to this configuration. Therefore, the solar cell 310 can have various shapes or structures such as a thin film solar cell, a semiconductor compound solar cell, a dye-sensitized solar cell, and an amorphous solar cell.

For example, the plurality of solar cell module-mounted plate 10 or the solar power generator 100 according to the present embodiment has a louver-like structure in which a plurality of solar cell module-mounted plates 10 can be partially or entirely overlapped with each other for adjusting the length of the blind or amount of light when the solar power generator 100 is applied to the manual or automatic blind. As another example, a plurality of solar cell module-mounted plate 10 or solar power generator 100 according to the present embodiment can be attached to a verandah, a railing, or the like. In this case, the plurality of solar cell module-mounted plates 10 are installed to have a predetermined inclination on the bottom surface or the vertical surface thereto, so that light incidence can be smoothly performed in a small space. However, the present disclosure is not limited thereto. The plurality of solar cell module-mounted plates 10 can be installed so as to be oriented in a direction perpendicular to the bottom surface. In such a structure, a fixing unit for installing the plurality of solar cell module-mounted plates 10 or a solar power generator 100 on the veranda, railing, or the like can be used. The fixing unit can have various constructions.

In the above description, it is exemplified that a separate junction box is not provided. However, the present disclosure is not limited thereto. Therefore, the junction box can be separately provided. The junction box can be installed at the same location as or adjacent to the plurality of solar cell module-mounted plates 10, or can be installed at a different location therefrom and can be electrically connected to the plurality of solar cell module-mounted plates 10.

The features, structures, effects and the like according to the above description are included in at least one embodiment of the present disclosure, and are not necessarily limited to only one embodiment. Further, the features, structures, effects, and the like illustrated in the embodiments can be combined with those of other embodiments or can be modified by other persons skilled in the art to which the embodiments belong. Accordingly, all such combinations and modifications are to be construed as being included within the scope of the present disclosure.

What is claimed is:

1. A solar power generator comprising:
a plurality of solar cell module-mounted plates, each solar cell module-mounted plate having an elongate shape extending in a first direction, the plurality of solar cell module-mounted plates being connected in parallel with each other,
wherein each solar cell module-mounted plate includes:
an elongate plate extending in the first direction; and
a plurality of solar cell modules mounted on the elongate plate, and
wherein each of the plurality of solar cell modules includes a plurality of solar cells.

2. The solar power generator of claim 1, wherein each of the plurality of solar cells has a rear-face electrode structure, and
wherein each of the plurality of solar cell modules includes a circuit board having a pattern defined thereon to serially connect the plurality of solar cells.

3. The solar power generator of claim 1, wherein the solar power generator is used as a blind including each solar cell module-mounted plate as a slat of the blind.

4. The solar power generator of claim 1, wherein each of the plurality of solar cells has an area of 100 mm² to 2120 mm², and
wherein each solar cell module-mounted plate includes 14 to 60 of the plurality of solar cells.

5. The solar power generator of claim 1, further comprising an inverter to convert direct current generated from the plurality of solar cell module-mounted plates or the plurality of solar cell modules mounted on each solar cell module-mounted plate into alternate current,
wherein a total output voltage from the plurality of solar cells located on each solar cell module-mounted plate is higher than a starting voltage for the inverter.

6. The solar power generator of claim 5, wherein the plurality of solar cell module-mounted plates are connected to the inverter without a bypass diode.

7. The solar power generator of claim 1, wherein a total output voltage from the plurality of solar cells located on each solar cell module-mounted plate is 15V or greater.

8. The solar power generator of claim 1, wherein each of the plurality of solar cells has a long side and a short side, and
wherein the long side of each of the plurality of solar cells extends in a second direction intersecting the first direction.

9. The solar power generator of claim 2, wherein the circuit board is located on one face of each of the plurality of solar cells, and
wherein each of the plurality of solar cell modules further includes a cover member located on an opposite face of the plurality of solar cells, and a sealing member positioned between the plurality of solar cells and the cover member.

10. The solar power generator of claim 1, wherein in each solar cell module-mounted plate, each of the plurality of solar cell modules includes the plurality of solar cells connected in series.

11. The solar power generator of claim 1, wherein each of the plurality of solar cell modules is connected to an adjacent solar cell module, or to an external circuit via a conductive connector.

12. The solar power generator of claim 1, wherein each of the plurality of solar cells includes a plurality of first electrodes and a plurality of second electrodes that extend in the first direction, and
wherein the plurality of first electrodes and the plurality of second electrodes are arranged alternatingly in a second direction intersecting the first direction.

13. The solar power generator of claim 1, wherein each of the plurality of first electrodes includes a first connection portion, and
wherein each of the plurality of second electrodes includes a second connection portion.

14. A solar power generating blind device comprising:
a plurality of slats, each slat having an elongate shape extending in a first direction, and the plurality of slats being connected in parallel,
wherein each slat includes:
an elongate plate extending in the first direction; and
a plurality of solar cell modules mounted on the elongate plate;
wherein each of the plurality of solar cell modules includes:
a plurality of solar cells, each solar cell having a rear-face electrode structure; and
a circuit board to connect the plurality of solar cells in series.

15. The solar power generating blind device of claim 14, wherein each of the plurality of solar cells has a long side and a short side, and
wherein the long side of each of the plurality of solar cells extends in a second direction intersecting the first direction.

16. The solar power generating blind device of claim 14, wherein each of the plurality of slats is connected to an adjacent slat in parallel via a plurality of connectors.

17. The solar power generating blind device of claim 14, wherein each of the plurality of solar cells includes a plurality of first electrodes and a plurality of second electrodes that extend in the first direction, and
wherein the plurality of first electrodes and the plurality of second electrodes are arranged alternatingly in a second direction intersecting the first direction.

18. A solar power generator comprising:
at least two solar cell module-mounted plates connected in parallel;
an inverter to convert direct current generated from the at least two solar cell module-mounted plates into alternate current; and
a plurality of connectors to connect the least two solar cell module-mounted plates to the inverter in parallel,
wherein each solar cell module-mounted plate includes:
a plurality of solar cell modules connected in series from one end to an opposite end of each solar cell module-mounted plate in a first direction.

19. The solar power generator of claim 18, wherein each solar cell module includes:
a plurality of solar cells; and
a circuit board to connect the plurality of solar cells in series,
wherein each of the plurality of solar cells has a long side and a short side, and
wherein the long side of each of the plurality of solar cells extends in a second direction intersecting the first direction.

20. The solar power generator of claim 19, wherein each of the plurality of solar cells includes a plurality of first electrodes and a plurality of second electrodes that extend in the first direction, and
wherein the plurality of first electrodes and the plurality of second electrodes are arranged alternatingly in the second direction.
